(19) United States
(12) Patent Application Publication
(10) Pub. No.: US 2010/0158009 A1
(43) Pub. Date: Jun. 24, 2010

(54) HIERARCHICAL PACKET PROCESS APPARATUS AND METHOD

(75) Inventors: Sang-min LEE, Daejeon-si (KR); Jung-hee LEE, Daejeon-si (KR); Bhum-cheol LEE, Daejeon-si (KR); Bong-tae KIM, Daejeon-si (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon-si (KR)

(21) Appl. No.: 12/626,009

(22) Filed: Nov. 25, 2009

(30) Foreign Application Priority Data
Dec. 19, 2008 (KR) 10-2008-0130631

(51) Int. Cl. H04L 12/56

(52) U.S. Cl. 370/392

(57) ABSTRACT

Provided is a hierarchical packet processing apparatus and method. In one general aspect, a packet is analyzed, divided into an upper layer and a lower layer. It is determined whether a property of the packet to be analyzed has been already analyzed or has to be re-analyzed with respect to each of the upper and lower layers of the packet. Therefore, deep packet inspection is performed only when it is required, and thus assurance of quality of service (QoS) during packet processing can be achieved, as well as reduced waste of resources.

### CROSS REFERENCE TO RELATED APPLICATION

This application claims the benefit under 35 U.S.C. §119(a) of Korean Patent Application No. 10-2008-0130631, filed on Dec. 19, 2008, the disclosure of which is incorporated by reference in its entirety for all purposes.

### BACKGROUND

1. Field

The following description relates to a packet processing technology, and more particularly, to a technology for processing and classifying packets such that traffic can be appropriately transmitted to a user according to a property of an application service in a packet-based communication system such as a router.

2. Description of the Related Art

Generally, a router system is primarily based on a best-effort service which processes all input packets using the same scheme regardless of a type of an application service.

However, since various types of services including Internet television (IPTV) service, a streaming service, a peer-to-peer (P2P) service and a voice over Internet protocol (VoIP) phone service are introduced and such services are to be processed on a single integrated network, traffic of each service needs to be transmitted while traffic properties are satisfied, and thus the best-effort service cannot meet the demands of users.

Conventionally, when traffic is transmitted over an integrated network, aimed at real-time transmission, a method of classifying and processing the traffic on a micro flow basis is utilized. A micro-flow based packet processing method defines packets of lower layers (a network layer and a transport layer) having the same properties on a micro-flow basis, and elements for quality assurance are identified on the micro-flow basis. Therefore, if packets are processed on the micro-flow basis, service quality of each micro-flow can be assured even in a network having various types of services integrated and mixed.

However, since this method is impossible to identify types of all application services with only analysis on a micro-flow basis, technologies to recognize thoroughly the traffic properties using information of upper layers have been introduced.

In this regard, one of the most recognized techniques is deep packet inspection (DPI). DPI uses information of upper layers to process packets, and mainly analyses packet information of between a layer 4 and a layer 7. The DPI is usually deployed for special functions such as security and filtering, and for such purpose, packet properties are analyzed by DPI which is implemented in software manner in order to transmit the packets in a form appropriate to the result of the analysis, deterioration in packet process performance may occur.

### SUMMARY

Accordingly, in one aspect, there is provided a hierarchical packet processing apparatus and method which prevents deterioration of packet processing performance while performing deep packet inspection (DPI). More specifically, the hierarchical packet processing apparatus and method analyzes a packet by dividing the packet into an upper layer and a lower layer, and determines whether a property of the packet to be analyzed has been already analyzed or has to be re-analyzed with respect to the respective upper and lower layers of the packet.

In one general aspect, there is provided a hierarchical packet processing apparatus including: a header analyzing unit to determine whether a property of an input packet can be identified using a lower layer header of the packet; and a flow processing unit to classify the packet through analysis of the lower layer header when the property can be identified, or to classify the packet through analysis of the lower layer header and deep packet inspection when the property cannot be identified.

In another general aspect, there is provided a hierarchical packet processing method of classifying an input packet according to a property of the packet, the packet processing method including: classifying, when the property of the packet can be identified by analyzing a lower layer header, the packet using information of the lower layer header, processing a first arriving packet of the classified packets by use of all information related to packet transmission, and processing the remaining packets of the classified packets by use of some of the information related to packet transmission; and classifying, when the property of the packet cannot be identified by only analyzing the lower layer header of the packet, the packet using the information of the lower layer header and deep packet inspection, processing the first arriving packet of the classified packets by use of all the information related to packet transmission, and processing the remaining packets of the classified packets by use of some of the information related to packet transmission.

It may be determined that the property can be identified by analysis of a packet header when a destination port number of a transmission control protocol (TCP) header or user datagram protocol (UDP) header of the packet is a well-known port number and a type of an application service or a quality of service (QoS) level can be learnt from the destination port number.

The data related to packet transmission may include a flow management table or a protocol management table, and classification of the packet may be performed by lookup of at least one of the flow management table and the protocol management table.

The deep packet inspection may acquire a property including an application service or an application protocol by use of pattern matching based on information of an upper layer header or payload of the packet and the packet may be classified based on the acquired property.

When the property of the packet cannot be identified even by the deep packet inspection, it may be determined whether the packet is encrypted, and encryption code of the packet, if possible, may be decrypted, or otherwise the packet may be discarded.

Other features will become apparent to those skilled in the art from the following detailed description, which, taken in conjunction with the attached drawings, discloses exemplary embodiments of the invention.

### BRIEF DESCRIPTION OF THE DRAWINGS

FIG. 1 is a block diagram illustrating a router according to an exemplary embodiment.

FIG. 2 is a block diagram illustrating a hierarchical packet processing apparatus according to an exemplary embodiment.

FIG. 3 is a flowchart illustrating a hierarchical processing method according to an exemplary embodiment.

FIG. 4 is a flowchart illustrating DPI process according to an exemplary embodiment.

FIG. 5 is a diagram illustrating packet process state according to an exemplary embodiment.

Elements, features, and structures are denoted by the same reference numerals throughout the drawings and the detailed description, and the size and proportions of some elements may be exaggerated in the drawings for clarity and convenience.

### DETAILED DESCRIPTION

The following detailed description is provided to assist the reader in gaining a comprehensive understanding of the methods, apparatuses and/or systems described herein. Various changes, modifications, and equivalents of the systems, apparatuses and/or methods described herein will suggest themselves to those of ordinary skill in the art. Descriptions of well-known functions and structures are omitted to enhance clarity and conciseness.

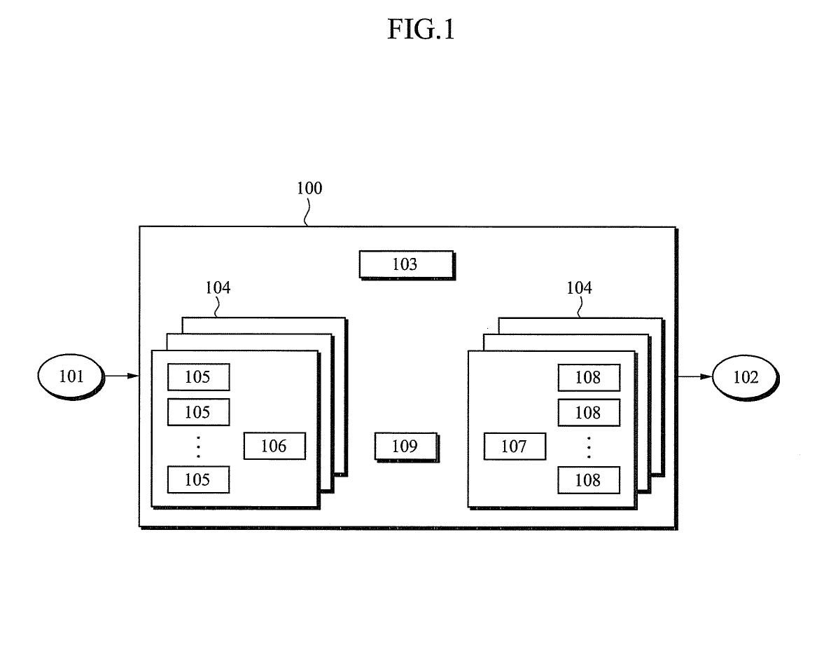

FIG. 1 is a block diagram illustrating a router 100 according to an exemplary embodiment. Referring to FIG. 1, the router 100 acts to connect a transmitting terminal 101 with a receiving terminal 102, process packets from the transmitting terminal 101 and transmit the processed packets to the receiving terminal 102.

The router 100 includes line cards 104, a processor block 103, and a switching fabric unit 109. The line cards 104 may include input physical layers 105, an input packet processing unit 106, an output packet processing unit 107, and output physical layers 108. The processor block 103 may store, process information regarding packet process and transmit the processed information to the line cards 104. The switching fabric unit 109 may be interposed between the input/output line cards 104.

The router 100 processes the packets received from the transmitting terminal 101, and transmits the processed packets to the receiving terminal 102. In addition, the router 100 may is classify the packets according to traffic properties while processing the packets. For example, in a case of real-time packets of an Internet protocol TV (IPTV) service or a streaming service, the router 100 may identify the traffic properties for quality of service (QoS) assurance and set priority for processing packets based on the identified properties or classify the packets according to the priority.

A hierarchical packet processing apparatus and method according to an exemplary embodiment is involved with the input packet processing unit 106 and the processor block 103 of the router 100.

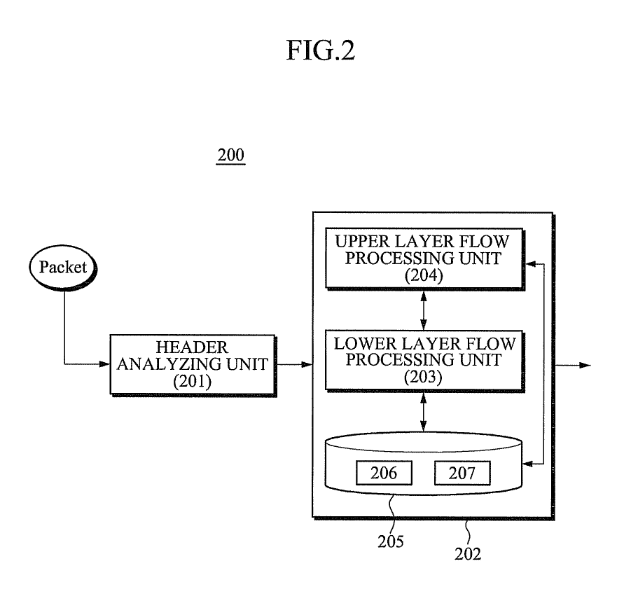

FIG. 2 is a block diagram illustrating a hierarchical packet processing apparatus 200 according to an exemplary embodiment. Referring to FIG. 2, the apparatus 200 includes a header analyzing unit 201 and a flow processing unit 202.

The header analyzing unit 201 analyzes some fields in a lower layer header to determine whether or not it is possible to identify a packet property.

For example, if a protocol field value is 6 (i.e. the upper protocol is transmission control protocol (TCP)) or 17 (i.e. the upper protocol is user datagram protocol (UDP)) in a header of an Internet protocol (IP) frame, the header analyzing unit 201 may determine that the packet property can be identified when a destination port number or a source port number of a TCP header or a UDP header is a well-known port number and a type of an application service and a QoS property can be learnt from the port number.

The flow processing unit 202 uses some information of a lower layer header of each to packet to analyze a packet property, but, if it is determined that deep packet inspection (DPI) is required, the flow processing unit 202 uses not only the information of the lower layer header of the packet, but also the result of DPI, and outputs the analyzed packet property.

For example, if the flow processing unit 202 can identify the packet property using the result of the analysis by the header analyzing unit 201, the flow processing unit 202 analyzes only a lower layer header of each packet to classify the packets, or otherwise, the flow processing unit 202 analyzes the lower layer header of the packet and executes deep packet inspection to classify the packets. To this end, the flow processing unit 202 may include a lower layer flow processing unit 203, an upper layer flow processing unit 204, and a table storing unit 205.

The table storing unit 205 may store information related to packet process.

For example, a flow management table 206 containing property information including whether to terminate a service, a service level, and port information may be stored in the table storing unit 205 based on 5-tuple information including a destination IP address, a source IP address, a protocol ID, a destination port number, and a source port number. Additionally, a protocol management table 207 for DPI may be stored in the table storing unit 205.

If it is determined that packet properties can be classified with only information of the lower layer header according to the result of the analysis by the header analyzing unit 101, the lower layer flow processing unit 203 is activated.

The lower layer flow processing unit 203 may perform lookup on the flow management table 206 to classify the packets.

However, when the flow management table 206 does not include corresponding traffic information of an input packet since the input packet is the first arriving packet, the lower layer flow processing unit 203 may regard this packet as a new packet and process the packets using all data (i.e., all information involved with packet processing) stored in the table storing unit 205. For example, the lower layer flow processing unit 203 may search the protocol management table 207 for the exact property of a corresponding application service, and store or update the found property in the flow management table 206. As the result, the subsequent packets can be processed by only using the flow management table 206.

If the result of the analysis by the header analyzing unit 201 shows that the property is classification is not possible only with the lower layer header information, the upper layer flow processing unit 204 is activated.

The upper layer flow processing unit 204 conducts packet processing not only with the lower layer header information of the packet, but also through DPI.

For example, the upper layer flow processing unit 204 may obtain properties including an application service or an application protocol by performing pattern matching using an upper layer header or payload information of a packet, and classify packets based on the obtained properties.

Furthermore, the upper layer flow processing unit 204 may perform lookup on the flow management table 206 to classify the packets. In this case, if there is no corresponding traffic information in the flow management table 206, an input packet is the first arriving packet, and hence the upper layer flow processing unit 204 may search the protocol management table 207 for a property appropriate to a corresponding application service, and update or store the identified property in the flow management table 206. Accordingly, the subsequent packets can be processed using only the flow management table 206.

As such, the packet processing apparatus 200 is not limited to a best-effort service and can provide a QoS-assured service in a communication system such as the router 100.

In other words, upon receipt of a packet, the packet is primarily processed using some fields of a lower layer header of the packet, and then if an application service is identified based on only a port number and traffic property analysis is possible, a database, i.e., a flow management table may be looked up to check if there is information of other packets that can be classified together with the currently input packet, and then the packet classification may be performed. However, if there is no traffic information corresponding to the input packet in the flow management table, the current flow is regarded as a new flow, and thus a number of databases are looked up to identify a property appropriate to a corresponding application service, the identified property is updated in the flow management table, so that packet transmission with respect to the subsequent packets in the same flow can be performed using the information updated in the packet management table.

If the result of primarily processing the packet shows that the port number is not a well-known number, DPI is performed to identify a type of an application service, and processes such as protocol management table search are conducted to obtain property information. Thereafter, the obtained property information is stored in the flow management table, and thus processing load for the other packets can be reduced in the same flow.

Alternatively, if the packet processing apparatus 200 cannot analyze a property of a packet through DPI, the packet processing apparatus 200 may determine whether traffic is encrypted, and the packet processing apparatus 200 may transmit the packet using the decoded information if the traffic can be decoded, or otherwise, discard the packet.

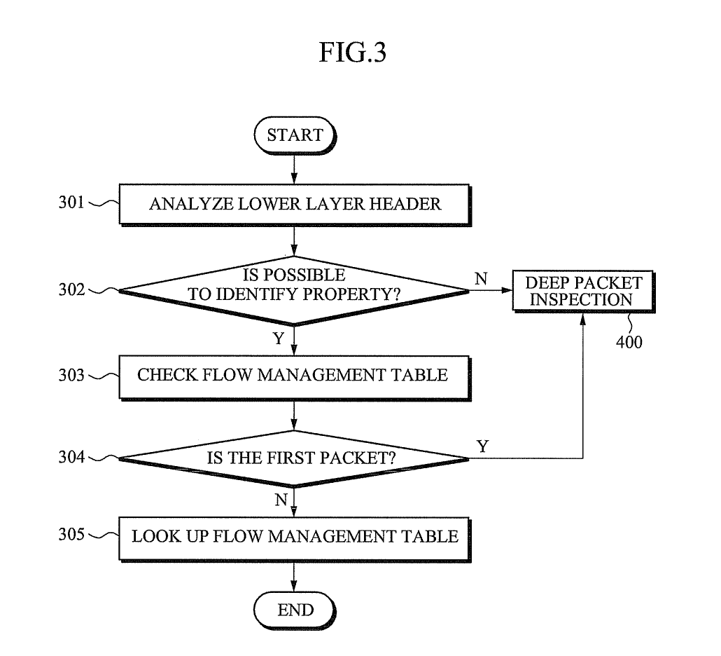

FIG. 3 is a flowchart illustrating a hierarchical processing method according to an exemplary embodiment. Referring to FIG. 3, at 301, some fields in a lower layer header are used to analyze an input packet.

At 302, it is determined whether or not a property of the packet can be identified. If the result of the determination indicates that the property cannot be identified and thus DPI is required, the procedure proceeds with 400 which will be described later. Otherwise, the procedure proceeds with 303.

At 303, a flow management table is checked. In other words, it is determined whether information of the property of the input packet is present in the flow management table. Then, at 304, it is determined whether the input packet is the first arriving packet. If there is no information corresponding to the input packet in an entry of the flow management table, the input packet can be regarded as the first input packet.

DPI is performed on the input packet which is determined as the first packet to identify a characteristic of an application layer at 400, and if the input packet is not the first arriving packet, at 305, the flow management table is looked up to perform packet classification and packet process.

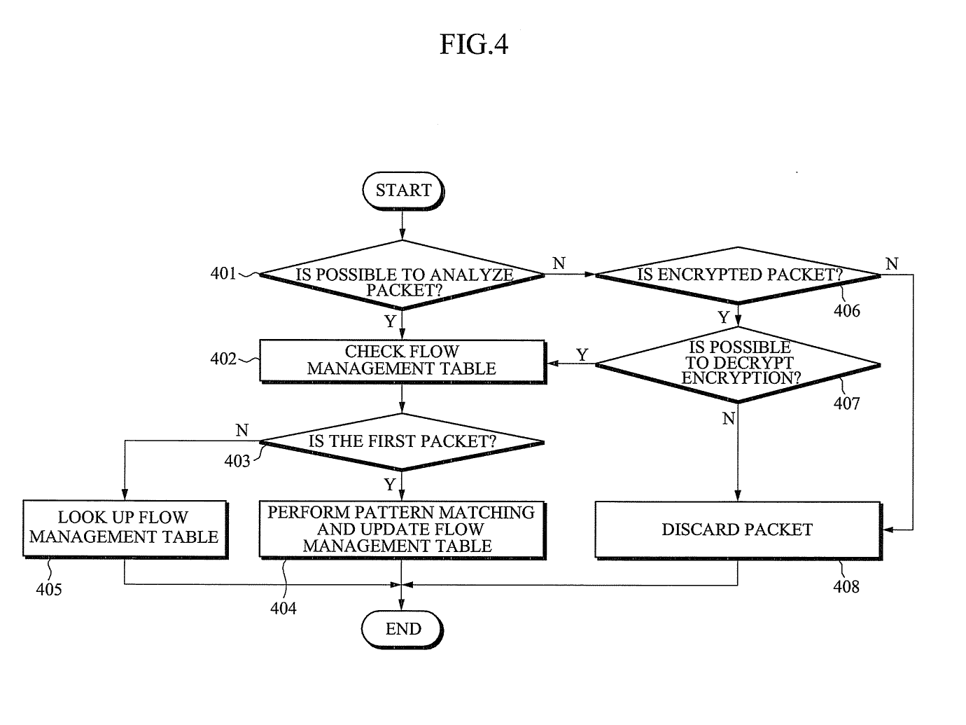

FIG. 4 is a flowchart illustrating DPI process according to an exemplary embodiment. This process may be an example of 400 of FIG. 3.

Referring to FIG. 4, at 401, it is determined whether a packet property can be analyzed by DPI.

When it is determined that the packet property can be analyzed, a flow management table is searched at 402 to detect whether the same flow is present. If there is no information corresponding to the packet, the input packet can be regarded as the first input packet.

Specifically, it is determined, at 403, whether or not the packet is the first input packet, and when the packet is the first input packet, at 404, pattern matching is performed to identify the packet property and the flow management table is updated using the identified packet property. Furthermore, because even when the packet is not the first input packet, the information relevant to the packet has been already updated, at 404, in the flow management table, packet classification and packet process are possible, at 405, through looking up the flow management table.

Meanwhile, if it is determined, at 401, that the packet property is impossible by DPI, at 406, it is determined whether the packet is encrypted or not. If the packet is encrypted, it is determined, at 407, whether it is possible to decrypt encryption code. If the packet analysis is not possible even when the packet is not encrypted or it is not possible to decrypt the encryption code, the packet is discarded at 408. However, when the decryption is possible, the procedure returns 402, and the subsequent procedures are performed the same as the above-described.

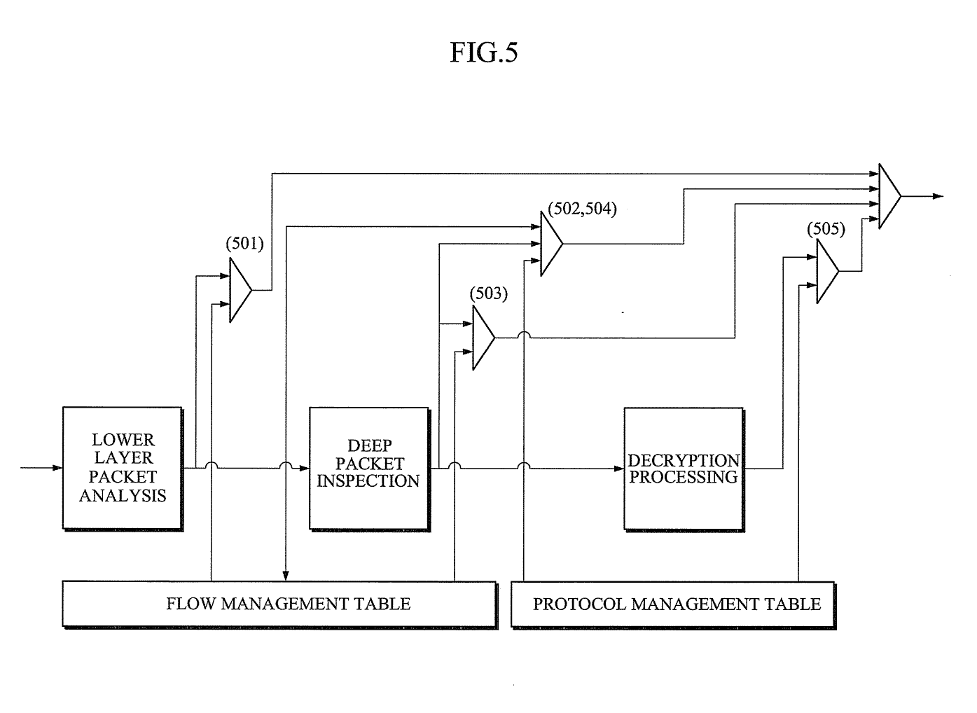

FIG. 5 is a diagram illustrating packet process state according to an exemplary embodiment. Referring to FIG. 5, reference numerals 501 and 502 represent lower layer flow process procedures. 501 represents a procedure of processing packets after the first packet among the packet category classified according to the same property. At 501, a flow status processing result and information of a flow management table of a line card are used to check and transmit information related to a path and QoS.

502 represents a procedure of processing the first packet among the packet category classified according to the same property. 502 may be performed when a type of an application service is identified but information corresponding to the current flow is not found in the flow management table. DPI is executed to check whether the current application service is the same as the known application service, and information regarding the DPI is collected from a protocol management table. The collected information is stored in the flow management table, so that packet processing for the same flow can be performed based on the stored information.

Hence, the first packet among the packets having the same property undergoes the process 502, and the remaining packets undergo the process 501.

Reference numerals 503, 504, and 505 represent upper layer flow process procedures. At 503 and 504, a packet property can be identified by DPI of the packet.

Packets following the first packet among the packets classified into the same category are processed at 503. Since the type of an application service can be detected only by DPI, 503 is executed differently from 501. Because a property can be assigned to a packet only after the DPI, once the type of the application service is identified, packet transmission is possible using information stored in the flow management table.

At 504, the first packet among the packets classified into the same category is processed. That is, in a case of a flow where the property of the packet is identified not by lower layer analysis, but by DPI, the first packet is processed at 504, and the remaining packets are processed at 503.

At 505, a packet of which property cannot have been analyzed even by DPI is processed. The packet of which property is impossible to be analyzed even by DPI is regarded as encrypted, and thus decryption is performed on the packet. When encryption code is successfully decrypted, the packet becomes transmittable. Otherwise, the packet is discarded.

As described above, packet processing is performed, divided into lower layer flow processing and upper layer flow processing, and packets classified into the same category are processed differently according to whether properties of the packets have been already analyzed or not, and hence deep packet inspection (DPI) is performed only on the packets in need, thereby reducing waste of resources. Moreover, since a complete single analysis of packets having the same property is performed based on a flow management table, load for analyzing the other packets in the flow can be reduced.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A hierarchical packet processing apparatus comprising:
a header analyzing unit to determine whether a property of an input packet can be identified using a lower layer header of the packet; and
a flow processing unit to classify the packet through analysis of the lower layer header when the property can be identified, or to classify the packet through analysis of the lower layer header and deep packet inspection when the property cannot be identified.

2. The hierarchical packet processing apparatus of claim 1, wherein the header analyzing unit determines that the property can be identified when a destination port number or a source port number of a transmission control protocol (TCP) header or user datagram protocol (UDP) header of the packet is a well-known port number.

3. The hierarchical packet processing apparatus of claim 1, wherein the flow processing unit, when the input packet is the first arriving packet, processes the packet using all data related to packet transmission, or otherwise processes the packet using some of the data.

4. The hierarchical packet processing apparatus of claim 3, wherein the data related to packet transmission includes a flow management table or a protocol management table, and classification of the packet is performed by lookup of at least one of the flow management table and the protocol management table.

5. The hierarchical packet processing apparatus of claim 4, wherein when the packet is the first arriving packet, the flow processing unit identifies the property of the packet by deep packet inspection or pattern matching and stores or updates the identified property in the flow management table.

6. The hierarchical packet processing apparatus of claim 1, wherein the analysis of s the lower layer header acquires a property of the packet, which contains a destination port or QoS information, by use of packet's lower layer header information and the packet is classified based on the acquired property.

7. The hierarchical packet processing apparatus of claim 1, wherein the deep packet inspection acquires a property including an application service or an application protocol by use of pattern matching based on information of an upper layer header or payload of the packet and the packet is classified based on the acquired property.

8. The hierarchical packet processing apparatus of claim 1, wherein the flow processing unit determines whether the packet is encrypted when the property of the packet cannot be identified even by the deep packet inspection, and decrypts encryption code of the packet, if possible, or otherwise discards the packet.

9. A hierarchical packet processing method of classifying an input packet according to a property of the packet, the packet processing method comprising:
classifying, when the property of the packet can be identified by analyzing a lower layer header, the packet using information of the lower layer header, processing a first arriving packet of the classified packets by use of all information related to packet transmission, and processing the remaining packets of the classified packets by use of some of the information related to packet transmission; and
classifying, when the property of the packet cannot be identified by only analyzing the lower layer header of the packet, the packet using the information of the lower layer header and deep packet inspection, processing the first arriving packet of the classified packets by use of all the information related to packet transmission, and processing the remaining packets of the classified packets by use of some of the information related to packet transmission.

10. The hierarchical packet processing method of claim 9, further comprising:
determining whether the property of the packet can be identified by analyzing some fields in the lower layer header of the packet.

11. The hierarchical packet processing method of claim 9, wherein the first arriving packet is a packet input when a flow management table does not include information of the packet and the packets subsequent to the first packet are packets input when the flow management table includes information corresponding to the respective packets.

12. The hierarchical packet processing method of claim 9, wherein the deep packet inspection acquires a property including an application service or an application protocol by use of pattern matching based on information of an upper layer header or payload of the packet and the packet is classified based on the acquired property.

13. The hierarchical packet processing method of claim 9, further comprising:
determining whether the packet is encrypted when the property of the packet cannot be identified even by the deep packet inspection, decrypting encryption code of the packet, if possible, or otherwise discarding the packet.
